(19) United States
(12) Patent Application Publication
(10) Pub. No.: US 2006/0048186 A1
(43) Pub. Date: Mar. 2, 2006

(54) Method and apparatus for storing and accessing videos from a remote location

(76) Inventor: Eric Alterman, Jupiter, FL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/088,244

(22) Filed: Mar. 24, 2005

Related U.S. Application Data
(63) Continuation-in-part of application No. 10/928,750, filed on Aug. 30, 2004.
(63) Continuation-in-part of application No. 10/974,710, filed on Oct. 28, 2004.

(51) Int. Cl. H04N 5/445; G06F 13/00; H04N 7/025; H04N 7/10

(52) U.S. Cl. 725/45; 725/32; 348/14.01

(57) ABSTRACT

A method and apparatus that enables a remote application platform the ability to allow any Internet website to receive and play video contributions from its users. The application platform provides websites with a number of functions related to uploaded videos that requires only that websites place relevant code on their web pages. Among other things, videos may be approved, listed, played, rated, distributed and discussed. Once videos are uploaded and stored at a central repository, they are reviewed to determine the type of access, if any, that should be associated with a given video. A tracking device can be used to determine the number of requests that are made for a given video or how many times a video has been viewed. The central repository is available through a remote access point, which enables the videos to be access from any location or website.

### CROSS-REFERENCE TO RELATED APPLICATIONS

This application is a Continuation-in-Part to U.S. patent application entitled “METHOD AND APPARATUS FOR STORING AND ACCESSING VIDEOS,” filed Aug. 30, 2004, having a Ser. No. 10/928,750, and a Continuation-in-Part to U.S. patent application entitled “METHOD AND APPARATUS FOR STORING AND ACCESSING VIDEOS,” filed Oct. 28, 2004, having a Ser. No. 10/974,710, the disclosures of both applications are hereby incorporated by reference in their entirety.

### FIELD OF THE INVENTION

The present invention concerns videography. More particularly, the invention described herein relates to a remote application platform that enables any website to aggregate and provide access to videos contributed by visitors to that website. Moreover, the platform organizes and stores user-generated videos in a manner that enables a variety of supporting features and functions.

### BACKGROUND OF THE INVENTION

Modern video technology has made it easier for both professionals and amateurs to create their own videos. Additionally, the digital format of these videos has enabled these individuals to more easily transport and share their creations.

Increasingly, however, videographers are looking to share their creations with the general public on a larger scale. Previously, these individuals would create a medium or method by which they would make these videos available. These mediums could be video stores or specialty merchandise shops that would carry niche goods. The disadvantage with this method is that it is both expensive and not very effective. Many stores are reluctant to carry niche videos because of a perceived lack of demand and shelf space required.

With the advent of the Internet, these videos can be made available on a videographer's website. Though more readily available than with previous techniques, this method has a disadvantage in that a video hosted on a single website is very dificult to locate among millions of websites, and many videographers have neither the application development skills nor the financing necessary to host their own video-enabled websites. These difficulties are compounded when advanced features are required such as categorization, ratings and discussion boards. Further, most websites cannot adequately serve many videos in a scalable fashion such that many users can watch and interact with videos at the same time.

Using a search engine to locate a specific video topic generally produces inconsistent results because videos found sporadically on the Internet are not annotated, categorized or regularly described. Nor can search engines produce consistent, accurate and coordinated lists of videos by ranking, videographer and/or date,

Accordingly, there is a need for a method and apparatus for videographers to easily share their niche video product with a public looking to view, discuss and interact with specific video works. There is an additional need to provide Internet websites with hosted applications that allow them to invite their web visitors to upload, view and interact with videos without those websites having to undertake all the application development, hosting and administration tasks necessary to provide this functionality.

### SUMMARY OF THE INVENTION

The foregoing needs are met to a great extent by the present invention, wherein in one aspect an apparatus is provided that in some embodiments include a remote link from any website using the invention to a central application server and database repository where user-generated videos are located and accessible. Videos, in the preferred embodiment, are uploaded to a central application server repository and await approval. Upon approval, the videos are associated with particular categories and made available through an access point, which can be entered through a remote website. Access to the platform by remote websites is enabled by custom links and code provided by the application server during website registration.

In accordance with one embodiment of the present invention, a repository for accessing and storing videos includes a storage device, a plurality of categories, wherein a category is associated with a video that is located on the storage device, an uploader configured to permit the video to be transmitted to the storage device and an approver device configured to either reject or accept the video, choose screen grabs or selected portions of the video and/or provide additional functionality. The applicaton platform and repository are linked to remote websites in order to provide those websites with the ability to accept videos from their users. Users may also view, rate, discuss and interact with videos thru other links to the application platform.

If the approver device accepts the video, then access is permitted to the video. If the approver device does not accept the video, then access to the video is not immediately granted. By allowing access to the video, the video can be downloaded or viewed through links to websites employing the application platform.

In accordance with another embodiment of the present invention, a method for accessing and storing videos, wherein the method provides a remote Internet website with the ability to offer its users video uploading and viewing features along with other functionality. The method includes providing an option on the remote Internet website for uploading a video, wherein the option is configured to route a request for the option to the Internet application platform which includes a central repository configured to store, organize and play videos in a scalable, distributed fashion.

This method also includes determining whether to accept the video, associating a category with the video, and in response to accepting the video, permitting access to the video. Further elements to this embodiment may include uploading the video to the central repository and being able to search through the videos on the central repository by analyzing the categories, which are associated with the videos.

In this embodiment, the application platform and central repository can be accessed through a remote access point, which is linked to a computer network such as local area and wide area networks. In this embodiment, the network is the Internet. To access the video, in this embodiment, a visitor to any website employing the invention described herin logs in to a previously registered account.

In this embodiment, a forum such as a bulletin board, as well as a page with personal information is generated for each videographer when he registers/creates his account. This area serves as a location for other users to ascertain information on the videographer and their works.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of a central repository according to a preferred embodiment of the invention.

FIG. 2 is an illustration of one aspect of the account option according to the preferred embodiment of the invention.

FIG. 3 is an illustration of yet another aspect of the account feature according to the preferred embodiment of the invention.

FIG. 4 is an illustration of the video upload feature according to the preferred embodiment of the invention.

FIG. 5 is an illustration of the video viewing feature according to the preferred embodiment of the invention.

FIG. 6 is an illustration of the video approval feature according to the preferred embodiment of the invention.

FIG. 7 is an illustration of yet another alternate embodiment of the present invention.

FIG. 8 is an illustration of yet another alternate embodiment of the present invention which permits remote Internet websites to link to a central repository.

### DETAILED DESCRIPTION

The invention will now be described with reference to the drawing figures, in which like reference numerals refer to like parts throughout. An embodiment in accordance with the present invention provides an application platform and central repository to and from which videos are uploaded and downloaded. For a video uploaded to the application platform from any website, the video is first placed into an approval queue. The video is viewed and then accepted or rejected based upon a review of the video content among other things such as but not limited to the video's playability by standard video players. If the video is rejected, access is not permitted or substantially limited. The central repository includes a search feature that allows users to search for specific video content by attribute such as associated text and category. A benefit of the central application platform and repository is that it is a single location, where an individual can go to upload or download a video from any remote website using this invention. Further, the central repository is part of an application platform that allows complex interaction with video content and other users.

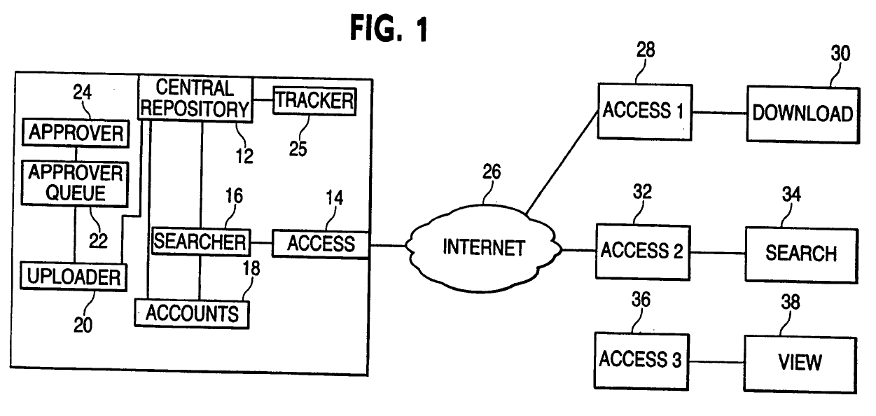

An embodiment of the present inventive apparatus and method is illustrated in FIG. 1. FIG. 1 is an illustration of a central repository and the related links to local and remote users. The present invention is a system 10, a central repository and application server, that includes a number of different components working together to permit users to access, retrieve and store data at a central location. The system 10 includes a central repository 12, where the videos are stored or located. The preferred embodiment uses a central database to store the videos. Alternate embodiments can use a number of different databases or storage units to store the items such that these devices are all linked to a central location.

To get access to the videos on the central repository 12, an access point 14 is provided for users through websites linked to the central application server. The access point 12 is a communications port that enables access from almost any location. The access point 12, in the preferred embodiment, is compatible with TCP/IP protocol and thus allows connections via computer networks such as the Internet. Alternate embodiments of the present invention permit access to other types of computer networks as well.

The access point 12, in the preferred embodiment, can be reached by knowing its uniform resource locator (URL) such as http://www.knowitallvideo.com or the address of any website that contains code linking its users to the application platform. By requesting access to the URL, a user is directed to the system 10.

Upon reaching a URL that is linked to the application platform, a user is provided with a plurality of data such as textual information concerning the service provided and a searcher 16. The searcher 16 is a tool that enables a user to discern which videos were stored or linked to the central repository 12. In the preferred embodiment, the searcher 16 contains a number of levels that help the user sort through a number of videos. The first level is a category level. The category level can be general or as specific as desired. For example, a video on gardening could be placed under the category home improvement. Once the category is selected, the searcher 16 responds with different categories such as landscaping, interior decorating and so on. The user could then select landscaping, which may contain additional categorization. A website that chooses to register to the application platform described herein can choose which particular categories and subcategories will be available to visitors to that particular website.

Each subcategory, subsubcategory existing in the system 10 and all websites using the invention described herein have their own bulletin board, which serves primarily as a discussion forum for videos associated with a particular category of videos and/or a particular website. This area would be used by potential viewers as one means to determine which videos they might like to view within a particular category of videos. The comments posted by previous users would be viewed by the potential viewers in order to aid them in the selection. The comments could also be directed to express a need for a particular type of video not yet stored within a particular category.

The searcher 16 of the present invention also is able to provide an alphabetical listing of the videos on the central repository 12 as well as a keyword search. All the various search functions of the searcher 16 provide the user a multitude of options in order to find a video that is most applicable to their needs such as by author, highest rated, most watched, most recent and/or category.

In the preferred embodiment, upon gaining entry to the system 19 through the access point 14, an account option 18 is provided for the user. The account option 18, in the preferred embodiment, requires that any user, who wants to download and upload a video, create an account with the account option 18. In this embodiment, it is not necessary for a user to sign into their account in order to use the searcher 16.

The account option 18 is used as a system to track videos and users. As is detailed in greater below, the account option 18 collects some minimal information in order to keep track of a user. The information can be as little as login name and e-mail address.

The account option 18 is linked to a database that can store a virtually limitless number of subscribers to the system 10. The database can be part of the central repository 12 or a separate database all together.

If a user desires to upload or transmit a video to the central repository 12, then an uploader 20 is provided for such a task. The uploader 20, once the user has logged into their account via the account option 18, alerts the system 10 that a video is being transmitted. Prior to uploading and in response to a request to upload, the system 10 determines which attributes to associate with the video. The attributes can be the video category, the date and time, screen grabs from the video, the video contributor's user name, photos, and any additional text provided.

In response to a request to upload and upon transmission of the video from the user, the system stores the received video in an approval queue 22. The system 10, in the preferred embodiment, does not permit access to a video unless it has been through an approval process and given the requisite permission by an approver 24.

The approval queue 22 is a location that stores or holds the videos transmitted through the uploader 20. The approver 24 then retrieves a video from the approval queue 22 in order to determine whether to grant its approval. In the preferred embodiment, the approver 24 is an option granted to an administrator. Upon viewing a video, the video is then associated with an accepted or rejected attribute. If the video is accepted, then the access is granted to the video. If the video is rejected, then access is not granted or substantially limited. Websites using the application platform can be provided with direct access to these and other administrative functions to manage videos and user participation.

If the video is accepted, then it is placed into the category/categories designated by the user, or the administrator, and made available to the searcher 16. At this point, the video is available for access on the central repository 12.

Videographer discussion boards and personal pages are created when the videographer creates an account. The discussion board can be accessed by viewers and those individuals, accessors, perusing the system 10. The discussion board serves as a forum where any of the viewers of the videographer's videos can enter their comments or remarks about one or more specific videos. For the accessors, it could serve as a basis for possible viewing of other works created by the videogrpaher. The comments could be reviewed by the accessor prior viewing the video works to determine if they would be interested in the videographer's work.

If the video is not accepted, the approver 24 generates a letter/email that is sent to the user informing them of the decision to accept or reject. The letter can be a standard rejection stating that it did not fall within the guidelines of the system or it could be more specific as to why it was rejected.

In alternate embodiments, the approver 24 contains an electronic checklist that includes a number of either specific or general entries that can be checked as to why a video is rejected. The approver 24 can also contain an area where text comments are entered. Upon completion of the rejection, the letter is automatically populated with the checked items and/or text comments. The preferred embodiment sends an e-mail, provided by the user when registering an account, that the video has been rejected.

The system 10 also includes a tracker 25. The purpose of the tracker 25 is to keep an account of how many times the video has been accessed or viewed. This data, in the preferred embodiment, is displayed for a user of the system as well for the individual who uploaded the video to the system 10. The data acts as a gauge for the viewer or videographer as to the potential or actual interest in the video. For example, if there are a significant number of requests for accesses to the video but little corresponding viewing of the film, then there could be a potential problem with the description of the video that is provided for a potential user.

As explained, the system 10, through the access point 14, is linked to the Internet. The Internet 26 enables almost any number of users to access the system 10 from any location as long as there is access to the Internet 26, and from links on the pages of any website using the invention as its video application platform. For example, a user 28 might wish to download 30 a video after they have just perused the system 10. Simultaneously, there might be a second user 32 that is using the system 10 and the searcher 16 to search 34 through the video inventory. The second user 32 might just be looking generally or for a specific item. Additionally, there might be a third user 36 that is in the process of viewing 38 a video online without the need to download it.

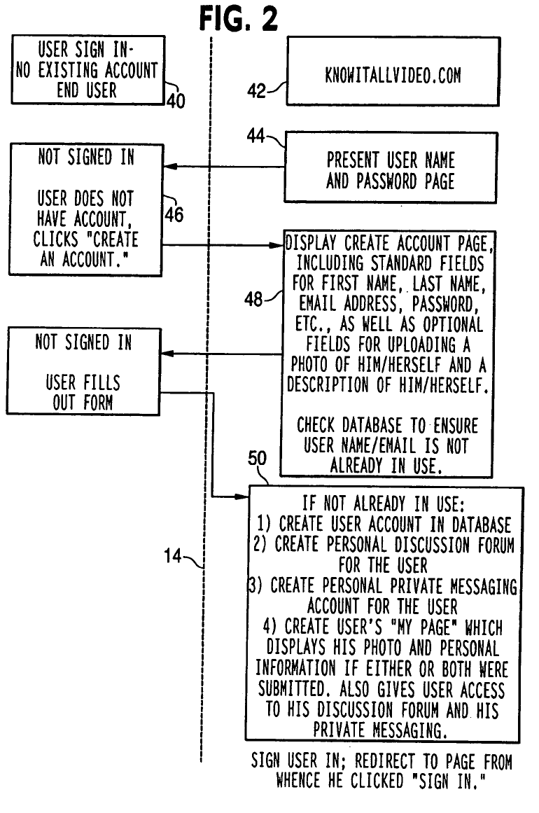

FIG. 2 is an illustration of one aspect of the account option according to the preferred embodiment of the invention. As discussed previously, the account option 18 provides a means by which a user is able to upload and download videos from the central repository 12 through the access point 14. In FIG. 2, the figure is divided into two sections, an end user section 40 and the system side 42.

The system side 42, with the related account option 18, is presented to the user either upon initial access to the system 10 or upon a request to access video associated with the central repository 12. In these events, the end user is presented with the account login screen 44, which requests the user to enter their user name and password. The system 10 responds with a message 46 that the present user is not signed in. There is an option on this page for those users that do not have an account, to create an account. If a non-account holder chooses the non-account option, then the user is presented with a new account form. The new account form 48 includes standard fields for first name, last name, e-mail address, password etc. In the preferred embodiment, the new account form 48 includes an option for uploading an image of the user as well as an area for providing a description of the user. The new account form 48 can be tailored or customized in any manner by the system 10.

Once all the information is collected from the user through the new account form 48, the system 10 checks its database for the user to ensure that the user name and/or e-mail is not already in use. If the user name and/or e-mail are not already in use, then an account is created through the account creation page 50. This step, in the preferred embodiment, creates a user account in the user database, creates a personal discussion forum for the use, creates a personal private messaging account for the user, and creates user's “My Page,” which displays his photo and personal information if either or both were submitted. The user is also given access to his discussion forum and his private messaging.

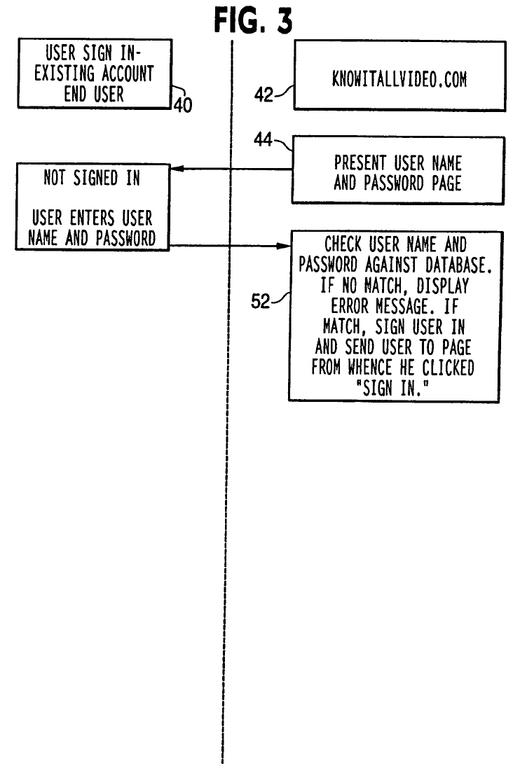

FIG. 3 is an illustration of yet another aspect of the account feature according to the preferred embodiment of the invention. FIG. 3 illustrates what a user with an account encounters each time it attempts to access the application platform repository 12. The user is presented with the account login screen 44, which requests a user name and the password. Upon entering the requisite information, the system uses a check step 52 to determine whether the entered information creates a match within its database. If there is a positive match, access is granted to the degree permitted by the system 10 upon setting up an account. Additionally, the user is returned to the position from where the user logged in. For example, if the user wanted to access a video on poker, then the user is returned to the video and granted access to view or download the video. If there is not a positive match, then the system 10, through the account database, returns an error message.

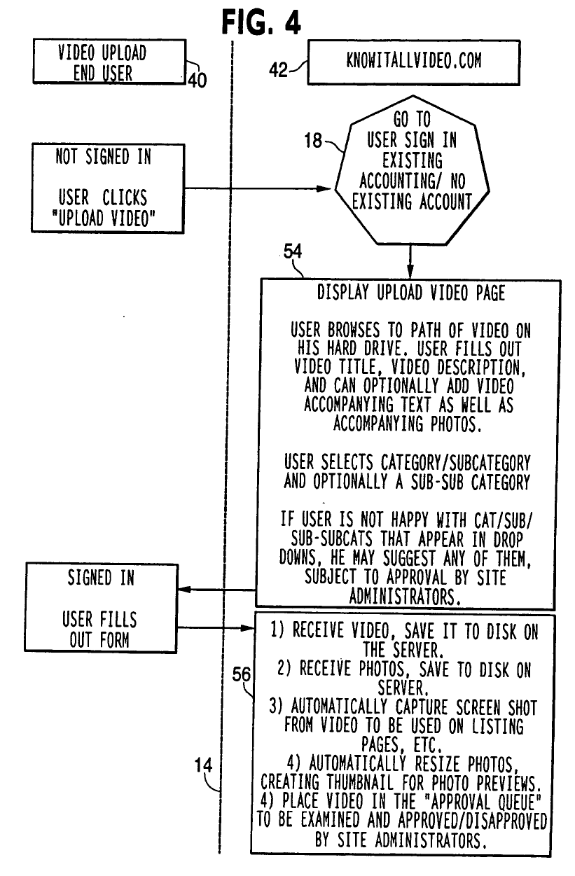

FIG. 4 is an illustration of the video upload feature according to the preferred embodiment of the invention. This figure discloses the process by which a video is uploaded to the system 10. The user accesses the system 10 through the access point 14, which is generally accomplished through a link on website using the system 10 to aggregate and share user-generated video content.

To upload the video to the system 10, the user must sign into their account through the account feature 18. If an account is not set up already, then the user would need to set up an account before proceeding.

Once the user is logged into the system 10, the user is presented with some options on how to proceed with the upload. One of the options is to direct the system 10 to where to find the video on the user's system through the display upload video option 54. For example, in the preferred embodiment, the present invention is implemented with a computer system. A user, through a computer, accesses the system 10. During the uploading procedure, a browse option is selected which directs the system 10 to where the video is residing on the user's storage unit, which, in the preferred embodiment, is a computer hard drive.

The display upload video option 54 also includes a list of categories from which the user can choose to associate the video. In alternate embodiments, there can also be subcategories. If the user is not happy with the categories or the subcategories that are present in the display upload video option 54, then the user may suggest a category or subcategory to the approver 24 or administrator.

In the alternate embodiments, the display upload video option 54 also includes options for a short preview of the video, accompanying text to include a short description of the video, ratings and other information that the user might think is useful or helpful to a potential viewer. Other possible options are contact information of the videographer or uploader and links or guides in order to obtain additional information.

After the display upload video option 54 is completed, the system 10 begins to receive, through the receive function 56, or accept the video from the user. The system 10 stores the video on the central repository 12. The system also stores any accompanying photos on the central repository 12. In the preferred embodiment, the photos are automatically resized, which creates essentially a thumbnail for photo previews. Furthermore, the video is placed in the approval queue 22, until it is approved or disapproved.

In the preferred embodiment, each time a video is uploaded to the system 10, it is placed in the approval queue 22. By placing it in this location, the access attributes to the video are strictly limited to the administrators. Once it is located in the approval queue 22, a message is sent to administrator informing them that a new video has been upload and available for review. Until the access attributes are changed, the video resides in the approval queue 22. Once it is approved, the access attributes are extended to those users that have created an account through the account option 18.

In the preferred embodiment, when a user creates an account, the system creates a home area or home page for that specific videographer. The home page includes a listing of all the videos submitted by the videographer, web links, photos, a discussion board and a message center. The home page is configurable by the videographer to include any other information desired.

The present invention also enables an account holder or user to publish their content through a Really Simple Syndication (RSS) service. By allowing this ability, the system 10 enables other sites to publish some of its content. To do this, the system 10 creates an RSS document and registers the document with an RSS publisher. A user, that can read RSS-distributed content, can use the content on a different site or location. Syndicated content includes such data as news feeds, events listings, news stories, headlines, project updates, excerpts from discussion forums or even corporate information.

Some of the search engine portal site on the Internet today enable a user to add the RSS service to an individual that has a registered account. For example, a registered account holder for YAHOO!® could link their YAHOO!® account to the system 10 such that it activates the RSS service provided by YAHOO!®. Therefore, a user would be updated through the YAHOO!® account when new data or additions are added to the system 10. The data can be specific such as to a category or videogrpaher or generally such as to anything new updated to the system 10.

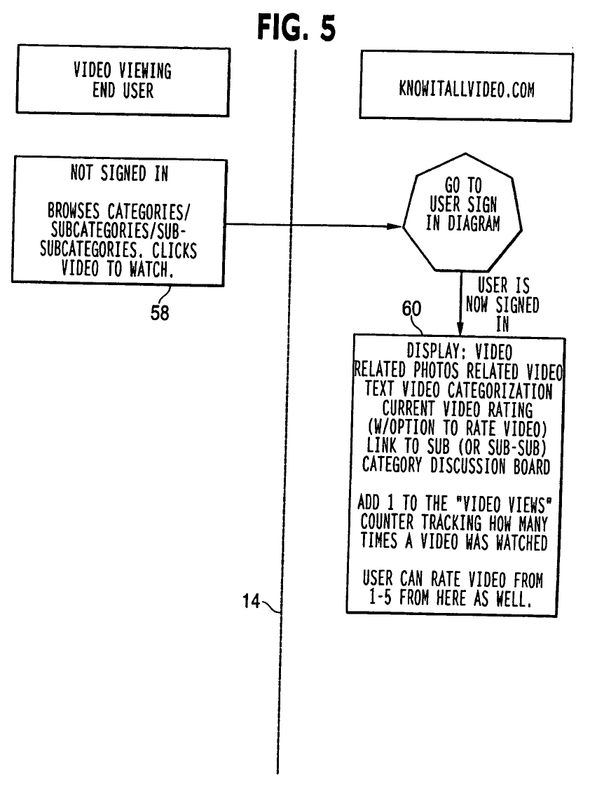

FIG. 5 is an illustration of the video viewing feature according to the preferred embodiment of the invention. In the preferred embodiment, a user is able to view a video through the access point 14. To do this, the user would access the requisite URL and then locate the video through the searcher 16. To view a video, the user would select the video and immediately be presented with the login option 58, which would require that the user enter in their user name and password. Verification is made against the entered data and the system account database. If the verification is positive, then the user is allowed access to the video through the display video option 60. In the preferred embodiment, the display video option 60 permits access to the video, related photos, related video text and the video associated category. If the user wants to continue and watch the video, the video is selected to be viewed.

The display video option 60, in alternate embodiment, can also include current video rating, which is made up of other users that have viewed the video and any related text. The rating is a number system such as 1 through 5 which is selected by the viewer. The system 10 tallies the rating and determines the overall average of the rating and displays it.

The preferred embodiment also includes a tracker 25 that keeps account of accessing and/or viewing of the video. In the preferred embodiment, a numerical number such as one (1) is added each time the video was viewed and a running tally is kept. In an alternate embodiment, the tracker 25 can also provide the view to hit ratio, which is a proportion of the number of actual views of the video to the number of requests to access.

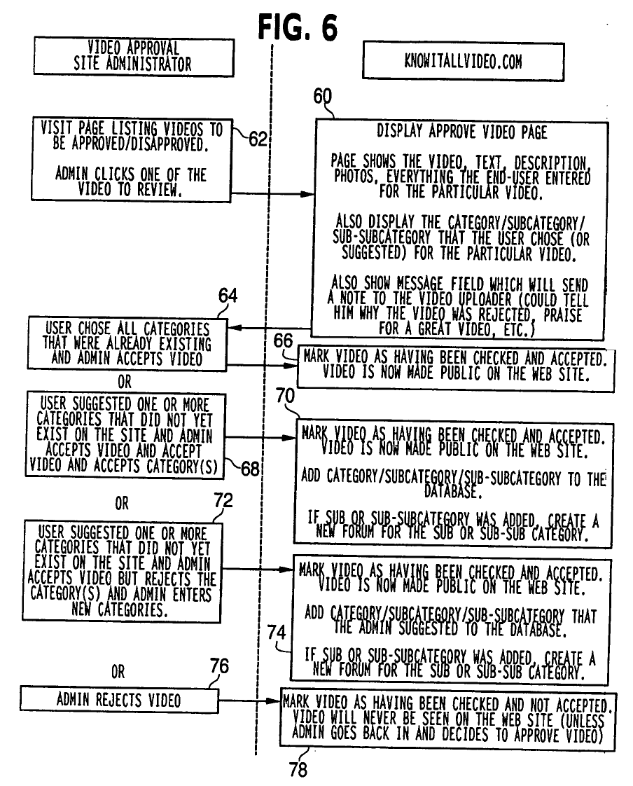

FIG. 6 is an illustration of the video approval feature according to the preferred embodiment of the invention. As previously detailed, each video, in the preferred embodiment, that is uploaded to the system 10 is passed through to the approver 24. The approver 24 generates a video listing, in the preferred embodiment, of all the upload videos that are waiting to be approved or disapproved. In the preferred embodiment, the administrator selects the videos to review and then either approves or disapproves the video. In alternate embodiments, the film approval or disapproval process can be accomplished automatically. One such example would be a script that would need to be submitted with the video. The script would then automatically be analyzed by the system to determine whether any of the video is not within the standards set out by the administrator. If the video is determined not to be within these standards, the video is not approved.

Upon selecting a video to view, the display video option 60 is made available to the site administrator. As discussed, the display video option 60 shows the video, text, description, photo and anything else the user entered when uploading the video to the system 10. The display video option 60 also includes the category and/or subcategory 64 that the user has chosen or suggested for the uploaded video. If the uploaded video is associated with an existing category and the video has been designated as accepted, then the video is publicly made available.

If the user suggested one or more categories 68 that did not exist, then the approver 24 has to determine whether to accept 68 the category suggested by the user. If the video has been analyzed and accepted, then public access is permitted to the video. Public access, if the account feature 18 is active, would be limited to those users that have obtained an account with the system 10.

After accepting the video, the approver 24 must determine if the proposed category 70 is to be accepted or added to the database. If the proposed category 70 or subcategory is accepted, then the system 10 automatically creates a new forum for the new category.

If the approver 24 accepts the video, but rejects 72 the new category, then the video category association is changed 74 by the approver to a new category. The changed 74 association can be accomplished in a number of different ways. In the preferred embodiment, the category is changed to an already existing category. Therefore, the administrator would select a category from the list of categories and link the video to it.

In an alternate embodiment, the same ability to change the association to an already existing category is available. Additionally though, the administrator can reject the suggested category and create a new category for the video. Therefore, the video will be linked to a newly created category that is different from the one suggested by the user.

If the approver 24 rejects 76 the video, then the video is marked as having been reviewed 78 but not accepted. Access on the system is not permitted for those other than the administrator. Note that it is possible for the administrator to restrict access to just themselves or a very limited number of users based upon the rejection. Full access is not permitted unless the administrator alters the rejection status to an approval status.

The present invention also enables users of the system 10 to share links to videos that might be of particular interest to other viewers. In the preferred embodiment, the user would select the video that they would like sent to another potential viewer of the video. Upon selection of the link, an e-mail is generated by the system 10 and sent to the potential viewer. In alternate embodiments, there can be location in the e-mail for comments by both system 10 and the user.

Additionally, the present invention enables a user to send a message to a videographer or user of the system 10 in order to send general comments or to request or inquire about specific items. In the preferred embodiment, the messaging is anonymous, which doesn't require the viewer to disclose themselves. By being anonymous, the viewer is more apt to be honest about critiquing the video or anything else about the videographer.

The preferred embodiment also contains a location where a user of the system 10 can request specific videos that are not yet available. This location is available to those users that have accounts with the system 10. At this location, the videographers are able to ascertain what particular demands or requests are being submitted by the requesters. The videographer can submit a video already covering this subject or begin to assembly one.

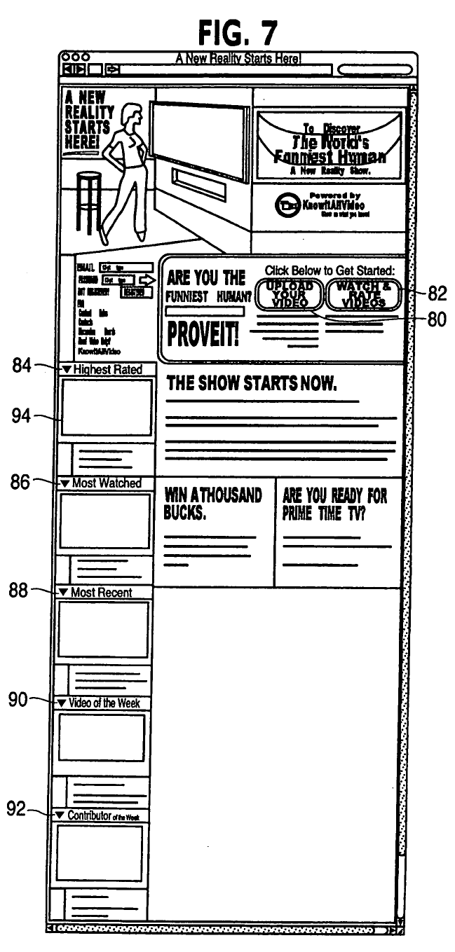

FIG. 7 is an illustration of yet another alternate embodiment of the present invention in which the present invention is used as an interactive tool for use with differing forms of media through their websites. Specifically, FIG. 7 illustrates the incorporation of the present invention with television media, specifically reality based television shows.

The present invention enables individuals to cast, submit or develop media concepts, such as reality based television shows, through an online process. The present invention allows any website associated with a reality television show to register with the application platform or system 10 to receive code that will provide dynamic links to the platform for a variety of functions. As an example of casting in regards to reality based television shows, potential participants transfer or upload their video through the video upload button 80. Once these videos or snapshots are uploaded, the videos can be made available immediately for viewing or the uploads can be stored with the approval queue 22. If the videos are placed in the approval queue 22, the system 10, in the preferred embodiment, does not permit access to a video unless it has been through an approval process and given the requisite permission by an approver 24.

With this embodiment, the videographers are also able to submit concepts for potential media projects as well, or in response to a radio show topic or magazine contest, for example. These concepts are uploaded and made available such that companies are exposed to potential ideas that would or could be popular on television. These videos can also be used by the companies as part of a research program that provides feedback as to the type of videos that the general public is interested in viewing. User-generated content and audience participation is have become increasingly important in this context, and the platform described herein uniquely enables functional, two-way interaction using digital video.

In uploading the video, the individual or uploader is granted additional space such as a “My page” where additional information concerning the individual or video may be located. The additional information may include, but not limited to, screenshots accompanying photographs and text descriptions. Additionally, a discussion board is generated or created for each person that uploads a video as discussed in the previous embodiment.

Once the videos are uploaded and approved, they are placed or located in a specific category such as subcategories or subsubcategories. The videos can be placed in such categories as type of humor (category), stand-up (subcategory), political or many others. The person uploading the video can place the video in an already existing category or can suggest a new one. Upon approval of the video, the video can be reassigned to another category, the videogrpaher's assigned category or the new category.

If the user suggested one or more categories 68 that did not exist at the time of uploading, then the approver 24 has to determine whether to accept 68 the category suggested by the user. If the video has been analyzed and accepted, then public access is permitted to the video. Public access, if the account feature 18 is active, would be limited to those users that have obtained an account with the system 10.

After accepting the video, the approver 24 must determine if the proposed category 70 is to be accepted or added to the database. If the proposed category 70 or subcategory is accepted, then the system 10 automatically creates a new forum for the new category.

If the approver 24 accepts the video, but rejects 72 the new category, then the video category association is changed 74 by the approver to a new category. The changed 74 association can be accomplished in a number of different ways. In the preferred embodiment, the category is changed to an already existing category. Therefore, the administrator would select a category from the list of categories and link the video to it.

In an alternate embodiment, the same ability to change the association to an already existing category is available. Additionally though, the administrator can reject the suggested category and create a new category for the video. Therefore, the video will be linked to a newly created category that is different from the one suggested by the user.

Once the video is available for viewing, any one with access to this embodiment is able to view and subsequently rate the video through the watch and rate selector 82. At this point, the video can be downloaded to the viewer's site or viewed online through this embodiment. Once viewed, the viewer is given the option of rating the video in any number of user-defined categories. For example, FIG. 7 details a reality based show based on the premise of the funniest human. Upon viewing the video, the viewer can be presented with a whole series of questions and/or ratings to determine the overall critique of this person's humor. The first question could be the following:

Question 1: Based upon your viewing of the video, how would rate this person's humor?
a. Extremely Humorous
b. Humorous
c. Somewhat Humorous
d. Not Humorous
   Based upon the viewer's opinion, the viewer selects a choice from the above question, which is then recorded and/or tallied by the current invention with all the other inputs received. The results of the ratings are gathered or collected by this embodiment and presents them to the users. The ratings, in this example, are used to determine which one of the uploaded videos contains the funniest human.

An affiliated television network could use the uploaded videos and related ratings to determine the casting for a show or concept or even for determining the winner of a contest. Therefore, audience participation and general interest is broadened beyond public auditions and interviews by professional casting directors.

This alternate embodiment could also be used for evaluating a prospective audiences' interest in television show concept or pre-promoting a television show online before it is aired or broadcast on television. The benefit of this is that potential audience members can become personally engaged with particular cast members or show themes in the months or weeks leading up to the television show's first broadcast. By gauging the interest before the showing, the television producers or networks can determine the interest level an adjust accordingly.

This alternate embodiment also enables the user of the system to search the central repository 12 in a user-defined manner. For example, the user may search or sort the videos by, but not limited to, highest rated 84, most watched 86, most recent 88, video of the week 90 and contributor of the week 92. The sorted videos can be presented with or without a screen shot for each video included in the sorted categories.

The screen shot in this embodiment, as well in the other embodiments, are automatically generated. The present invention generates the screen shots by randomly selecting shots from the uploaded video. In this embodiment, the approver selects from the screen shots which shot will appear with the listing of the uploaded video in its designated category. With each category, the selected screen is positioned along with the video. Referring to FIG. 7, the highest rated category 84, the number one listing, Leeza'a Old Car, is listed with the related screen shot 94.

Alternate embodiments of the present invention enable the screen shot to be manually generated by the present invention. The shots can be created by the approver manually selecting a specific point in the uploaded video. This screen shot then becomes associated with the video and positioned along side it in the designated category.

The present invention also enables the various existing categories to be automatically generated and presented to an accessor each time the present invention is viewed. (i.e., highest rated 84, most watched 86, most recent 88, video of the week 90 and contributor of the week 92). These category lists dynamically change or are updated as the videos are viewed, rated or uploaded and related tallies are determined. Referring to FIG. 7 as an example, the most watched category 86 is automatically and dynamically generated each time the accessor requests access to the present invention. The videos in this category are listed by the on-going tally to date. Therefore, for the most watched category 86, the top three most watches videos are “Super Rapper,” “Billy Boop” and “Once you were me,” which are based upon the current viewing tally for each of these videos. Another example would be the highest rated category 84 for which the category and its associated ratings are updated each time a viewer views and uploads the video. In FIG. 7, the highest rated video is “Leeza's Old Car,” which is the based upon the most recent tally as determined by the present invention.

In yet another embodiment of the present invention, the present invention is used in conjunction with another form of media such as broadcast radio. For example, radio shows, popular with many individuals, conducts a variety of contests such as to attract or retain listeners. An example of such a contest could be the “Funniest Radio Listener Personality” in which each listener would submit their video to the present invention thru a website registered to the platform for this purpose. Upon submission of the video, it is available to the general public such as the radio listening audience to be viewed and rated. A tally of the ratings is then submitted and used to select the winner of the contest.

Like the previous embodiments, this alternate embodiment permits the video to be uploaded and then placed in the appropriate category. In this embodiment, the primary location (category) would be the “Interactive Radio” followed by the subcategory Radio Show (i.e. Dave & Mike in the Morning, 106.7 FM) and then the sub-subcategory, which in this case would be the name of the contest such as the “Funniest Radio Listener Personality.”

The video is uploaded via the uploader 20 and then placed in the approval queue 22, where it located until it is approved or not. Upon approval of the video, it is placed in the Interactive Radio category and made available to the general public.

The viewing public is able to access the videos under the Interactive Radio category and view and/or rate the videos based upon the content or performance. Upon the rating of the videos, the present invention is able to produce a report that depicts how the videos were rated by the viewers. From this report, the radio station is able to determine a winner.

Similar to the previous embodiments, the display upload video option 54, in the radio media embodiment, also includes a list of categories from which the user can choose to associate the video. In alternate embodiments, there can also be subcategories. If the user is not happy with the categories or the subcategories that are present in the display upload video option 54, then the user may suggest a category or subcategory to the approver 24 or administrator.

In the alternate embodiments, the display upload video option 54 also includes options for a short preview of the video, accompanying text to include a short description of the video, ratings and other information that the user might think is useful or helpful to a potential viewer. Other possible options are contact information of the videographer or uploader and links or guides in order to obtain additional information.

After the display upload video option 54 is completed, the system 10 begins to receive, through the receive function 56, or accept the video from the user. The system 10 stores the video on the central repository 12. The system also stores any accompanying photos on the central repository 12.

Each subcategory and subsubcategory existing in the system 10 includes its own bulletin board, which serves primarily as a discussion forum for viewers of the videos to enter their comments about videos associated with the particular category. This area would be used by potential viewers as a possible means to determine which videos among a particular category to view. The comments posted by previous users would be viewed by the potential viewers in order to aid them in the selection. The comments could also be directed to express a need for a particular type of video within the category.

Videographer discussion boards and personal pages are created when the videographer creates an account as well as for each category, subcategory and sub-subcategories. The discussion board is able to be accessed by viewers and those individuals, accessors, perusing the system 10. The discussion board serves as a forum where any of the viewers of the videographer's videos can enter their comments or remarks about one or more specific videos. For the accessors, it could serve as a basis for possible viewing the works created by the videogrpaher. The comments could be reviewed by the accessor prior viewing the video works to determine if they would be interested in the videogrpaher. While for the viewers, it would most likely serve as a forum to discuss the positives and negatives of the videographer and their works.

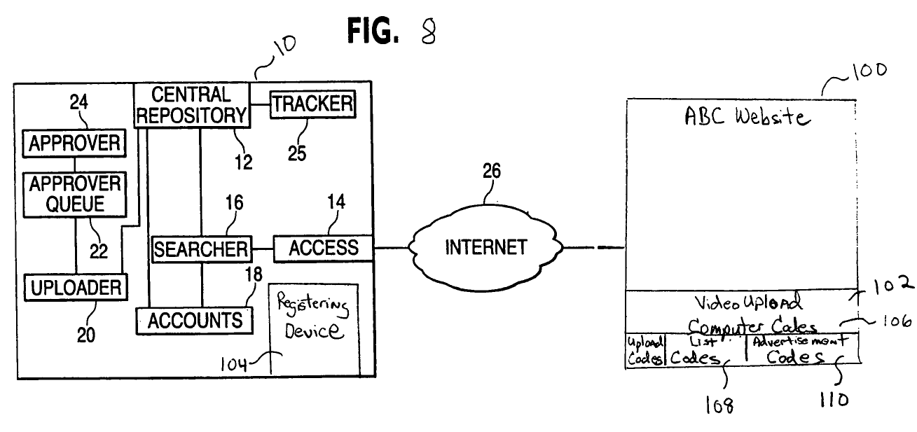

The present invention can be incorporated with other websites on the Internet as detailed in FIG. 8. For example, a website 100 has the ability to allow users to upload video content through the use of the present invention. The present invention is operated at a central location and therefore permits other websites to use a centrally located application platform as a host.

For example, ABC's website 100 desires to include video on their website but does not wish to independently develop a multi-functional upload, hosting and serving platform. An alternative to such a dilemma is to use a system 10 that includes a central platform or repository 12, which includes the abilities or option 102 of allowing videos to be uploaded and stored according the process previously discussed.

To incorporate this feature on ABC's website 100, an individual, such as a website administrator, signs up on the central website through a registering device 104. Upon signing up, information, such as but not limited to site name, website address, and the name of the category under which the website's videos appear, is provided. On a successful sign up, the website 100 is assigned a unique identifying code, and a subcategory under the main “Partner Sites” category that is contained in the central platform or repository 12.

The website administrator is then provided with instructions and special computer codes, 106 such as but not limited to computer executable code, computer instructions, links, and HTML tags. These codes are then pasted into their web page (e.g., “Upload Video” link). The website administrator can cut and paste the computer codes 106 such as HTML into the HTML source code of their website. Other code sets include but not limited to “All Videos”, “Add to My Yahoo”, “RSS”, “Add to My MSN RSS”, “Code for standard RSS”, “Search all KIAV users”, “Search partner site videos”, and “Upload buttons”.

Upon inclusion and activation of the computer code 106, the websites, such as ABC, then provides users with the ability or option 102 of uploading videos to the central platform 12. In this embodiment, ABC's uploaded videos appear under Partner Site's Category. As noted, the videos are not located or stored on ABC's website 100. All application functionality and video storage is handled by the application platform invention.

In this alternate embodiment, the video is uploaded and then placed in the appropriate category. In this embodiment, the primary location (category) would be the “ABC Website” followed by the subcategory or sub-subcategory if necessary or desired.

The video is uploaded via the uploader 20 and then placed in the approval queue 22, where it located until it is approved or not. Upon approval of the video, it is placed in the ABC Website category and made available to the general public that is viewing ABC's website.

The viewing public is able to access the videos directly from ABC's website and videos based upon the content or performance. Upon the rating of the videos, the present invention is able to produce a report or list that depicts how the videos were rated by the viewers. That list can be added to ABC's website by pasting appropriate code provided by the application platform.

Similar to the previous embodiments, the display upload video option 54, in this alternate embodiment, also includes a list of categories from which the user can choose to associate the video. In alternate embodiments, there can also be subcategories. If the user is not happy with the categories or the subcategories that are present in the display upload video option 54, then the user may suggest a category or subcategory to the approver 24 or administrator.

In the alternate embodiment, the display upload video option 54 also includes options for a short preview of the video, accompanying text to include a short description of the video, ratings and other information that the user might think is useful or helpful to a potential viewer. Other possible options are contact information of the videographer or uploader and links or guides in order to obtain additional information.

After the display upload video option 54 is completed, the system 10 begins to receive, through the receive function 56, or accept the video from the user. The system 10 stores the video on the central repository 12. The system also stores any accompanying photos on the central repository 12.

Each subcategory and subsubcategory existing in the system 10 includes its own bulletin board, which serves primarily as a discussion forum for viewers of the videos to enter their comments about videos associated with the particular category. This area would be used by potential viewers as a possible means to determine which videos among a particular category to view. The comments posted by previous users would be viewed by the potential viewers in order to aid them in the selection. The comments could also be directed to express a need for a particular type of video within the category.

Videographer discussion boards and personal pages are created when the videographer creates an account as well as for each category, subcategory and sub-subcategories. The discussion board is able to be accessed by viewers and those individuals, accessors, perusing the system 10. The discussion board serves as a forum where any of the viewers of the videographer's videos can enter their comments or remarks about one or more specific videos. For the accessors, it could serve as a basis for possible viewing the works created by the videogrpaher. The comments could be reviewed by the accessor prior viewing the video works to determine if they would be interested in the videogrpaher. While for the viewers, it would most likely serve as a forum to discuss the positives and negatives of the videographer and their works.

Also included in the computer codes 106 or links that are provided upon registering are links or list codes 108 that cause lists or categories to be included on the website such as the Most Recent, Most Watched, and Highest Rated videos that are uploaded to Partner Site's category. The website administrator need only paste ONE HTML tag per list into his HTML source. It is noted that website does not require a dynamic server side language, such as an ASP, JSP, etc. It is possible to use a website with static HTML. The lists themselves are dynamic lists from the system 10 are updated routinely. By including these codes 108 into the website, these lists are displayed and accessable from the website from where they are located.

For illustrative purposes, the following example is provided. Note that the present invention is not limited by the example. A website site such as XYZ News Station desires to allow video such as those received from home viewers to be uploaded for viewing on their website. These videos are most likely related to news related events. However, it is not likely, due to many technical requirements addressed by the present invention, that the website of XYZ News Station has the ability to allow videos to be uploaded in any fashion.

With the present invention, XYZ News Station does not need to have this independent capability. The present embodiment enables the website to include an uploading video feature but with none of the burdens associated with application development, hosting, serving or administration. These duties are now handled by an application platform that provides a location or database and related administration applications. XYZ News Station has essentially partnered with another application service provider to handle these features for them.

To enable these features on the XYZ website, an individual such as the website administrator registers with this central platform by providing relevant information. Upon providing the information, the central platform provides XYZ with a specific code that needs to be included or inserted in XYZ's website. Once the code is included in the website and the website is activated, a browser or user of the website is now able to upload video the XYZ New Station.

In an alternate embodiment, additional code may be entered in XYZ's website. For example, various categories such as MOST RECENT, MOST WATCHED, HIGHEST RATED can appear on XYZ's website as long as the related code is placed and activated. Once they appear on the website, these lists are available by merely selecting the item by clicking on the category. Once an item is selected, the video or item selected is retrieved from the central category. All other features and applications described herein can therefore be immediately adopted by any website with little effort or technical ability.

The computer code 106, obtained upon providing the information requested by the central platform also allows for advertising codes 110 to be placed or located in the area where the upload video option 102 code is activated. The advertising code 110, which is computer executable code, is capable of providing a static advertisement or dynamic advertisement. In the latter, the code 110 provides a routine such that it interacts with the central platform or partner on a periodic basis. For example, the routine is assembled such that the unique code pings the central platform on an hourly or daily basis. Each time or at each check-in, the central platform would respond with the new advertisement.

In another embodiment of the advertisement, the central platform 102 could actively distribute the code to the partner's website on a scheduled basis. Therefore, at each defined check-in point, the central platform would deliver the content for a new advertisement.

Finally, users can use the invention described herein to provide links from other websites and blogs to videos uploaded to the application platform. For example, if a user is posting text message on a blogging website he may include a link to a video that he previously uploaded to the application platform. Another user who subsequently reads his message can click on that link and watch the associated video, even though that blogging website, by itself, cannot host videos or provide related video applications.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An application service platform that allows any website to easily accept video uploads from its audience whereby such user-generated videos are stored, accessed, played, categorized, discussed, rated and displayed in a scalable, intuitive fashion, the system comprising:
a central repository and application server comprising:
a storage device;
a plurality of media categories, wherein a single media category is associated with a video that is located on the storage device;
an uploader configured to permit the video to be transmitted to the storage device; and
a rating system configured to permit rating of the video located on the storage device; and
a link that is configured to be placed on a remote Internet site, wherein the link routes a request to an alternate Internet website upon a request for access to the central repository and application server.

2. The system as in claim 1, wherein the central repository and application server is configured to manage videos, messaging users, providing video categories, providing search functions, and providing discussion boards.

3. The system as in claim 1, further comprising wherein the central repository further comprises a registering device that requests information.

4. The system as in claim 3, wherein the central repository is configured to provide the link upon providing the information.

5. The system as in claim 4, wherein the link is computer code.

6. The system as in claim 5, wherein the computer code is hypertext markup language (HTML).

7. The system as in claim 3, wherein the information requested comprises site name, website address and a category name.

8. The system as in claim 1, wherein the link is configured to provide an option on a remote Internet website for uploading a video.

9. The system as in claim 7, wherein the link is configured to provide and option for viewing an uploaded video.

10. The system as in claim 8, wherein the link provides a listing of videos that have been uploaded.

11. The system as in claim 10, wherein the link is separated into a plurality of categories.

12. The system as in claim 11, wherein the plurality of categories includes most watched, most recent and highest rated.

13. The system as in claim 8, wherein the link further comprises computer code that is configured to display an advertisement on the remote Internet website and on pages hosted by the application service platform.

14. The system as in claim 13, wherein the computer code is configured to dynamically change the advertisement.

15. A method for accessing and storing videos, wherein the method provides a remote Internet website with the ability to offer video uploading and viewing features, the method comprising:
providing an option on the remote Internet website for uploading a video, wherein the option is configured to route a request for the option to an application platform; and
upon a selection of the option, routing the request to the alternate application platform which comprises a central repository configured to store videos.

16. The method as in claim 15, wherein the step of providing an option further comprises:
registering at the alternate Internet website in order to provide the option on the remote Internet website; and
receiving an identifying code or coded graphical objects in response to registering on the alternate Internet website.

17. The method as in claim 16, further comprising placing the identifying code or coded graphical objects on the remote Internet site and activating the identifying code such that the option is available for use on the remote Internet website.

18. The method as in claim 16, wherein the identifying code further comprises computer executable code for displaying a listing of the videos associated with the remote Internet site.

19. The method as in claim 16, wherein the identifying code further comprises computer executable code for displaying an advertisement.

20. The method as in claim 19, wherein the advertisement is dynamic.

21. The method as in claim 17, wherein the identifying code is comprised of hypertext markup language (HTML).
